(19) United States
(12) Patent Application Publication
(10) Pub. No.: US 2001/0022773 A1
(43) Pub. Date: Sep. 20, 2001

(54) Compact disc of circular and non-circular shape

(76) Inventor: Bohumil Pergl, Lodenice (CZ)

Correspondence Address: NOTARO & MICHALOS P.C., EMPIRE STATE BUILDING, 350 FIFTH AVENUE, SUITE 6902, NEW YORK, NY, 10118, US

(21) Appl. No.: 09/805,345

(22) Filed: Mar. 13, 2001

(30) Foreign Application Priority Data
Mar. 15, 2000 (CZ) 2000-10508

(51) Int. Cl. G11B 3/70; G11B 5/84; G11B 7/26

(52) U.S. Cl. 369/272; 369/283

(57) ABSTRACT

A compact disc of circular and non-circular shape with a disc body comprising a central annular portion and a recording portion provided with a recording and reflective layer, protective coating and optionally with printing and used for special purposes such as advertisement, promotion, corporate presentations which is in the recording or a the central annual portion of the disc provided by at least one defined area containing a hidden printing and covered by a scratch-off paint.

### BACKGROUND OF THE INVENTION

The invention relates to a compact disc of circular or non-circular shape with a disc body comprising a central annular portion and a recording portion provided with a recording and reflective layer, protective coating and optionally with printing on a top side, and used for special purposes such as advertisement, promotion, corporate presentations etc.

### DESCRIPTION OF THE RELATED ART

It is generally known that compact discs, in abbreviation CD, for recording, storing and reproducing information may besides the conventional circular shape being 120 mm or 80 in diameter have also a non-circular shape used mainly for the purpose of advertisement promotion or corporate presentation actions. The manufacturers apply various methods in the effort to attract the attention of clients by means of compact discs, for example by producing discs in various shapes, by printings executed in conspicuous, attractive colors, by admixing perfumes, using holograms etc.

Nevertheless, none of the existing designs makes it possible to use compact discs as tickets for a lottery, for a hidden advertisement carrier etc.

### SUMMARY OF THE INVENTION

The object of this invention is to improve the existing compact discs of circular and non-circular shape with a disc body comprising a central annular portion and a recording portion provided with a recording and a reflective layer, protective coating and optionally with printing on a top side and which are designed to be used for special purposes such as advertisement, promotion and corporate presentations, by providing the upper surface of the disc by at least one defined area containing a hidden printing and covered by a scratch-off paint.

The main advantage of the invention is that the compact disc is provided in at least one defined area by a special scratch-off paint that may be easily removed by means of a coin or nail and that makes it possible to place under this cover paint a hidden information and to make use of such an surprising effect for an effective advertisement, promotion action etc.. An important advantage of this improvement in the compact disc design is that it may be used as a lottery ticket. In such a case the hidden numerals may by safely printed by so-called ink jet technology. Further, a compact disc of said embodiment may be used as an advertisement carrier containing a hidden advertisement slogan etc. In certain embodiments it may be advantageous that the surface of the defined area covered by a scratch-off paint is provided by an additional guidance printing with an information relating to the contents of the hidden printing.

### BRIEF DESCRIPTION OF THE DRAWINGS

The substantial features of the invention and its preferred embodiment will now be described with reference to the accompanying drawings where:

FIG. 1 shows a portion of a compact disc provided with two defined scratch-off areas;

FIG. 2 shows a detailed sectional view on the line A—A of FIG. 1 illustrating particular layers of the disc to a highly enlarged scale;

FIG. 3 shows a detailed sectional view on the line A—A of FIG. illustrating particular disc layers with a guidance printing;

FIG. 4 shows a detailed sectional view on the line B—B of FIG. of the central annular portion of the disc;

FIG. 5 shows a detailed sectional view illustrating individual disc layers where the defined scratch-off area is on the surface provided by a basic cover paint;

FIG. 6 shows a plan view of a compact disc having a circular shape provided with two defined scratch -off areas;

FIG. 7 shows a plan view of a compact disc in the non-circular shape of a tree provided with one defined scratch-off area;

FIG. 8 a plan view of a compact disc in the non-circular shape performed as a business card provided with one defined scratch-off area.

### DESCRIPTION OF THE PREFERRED EMBODIMENT

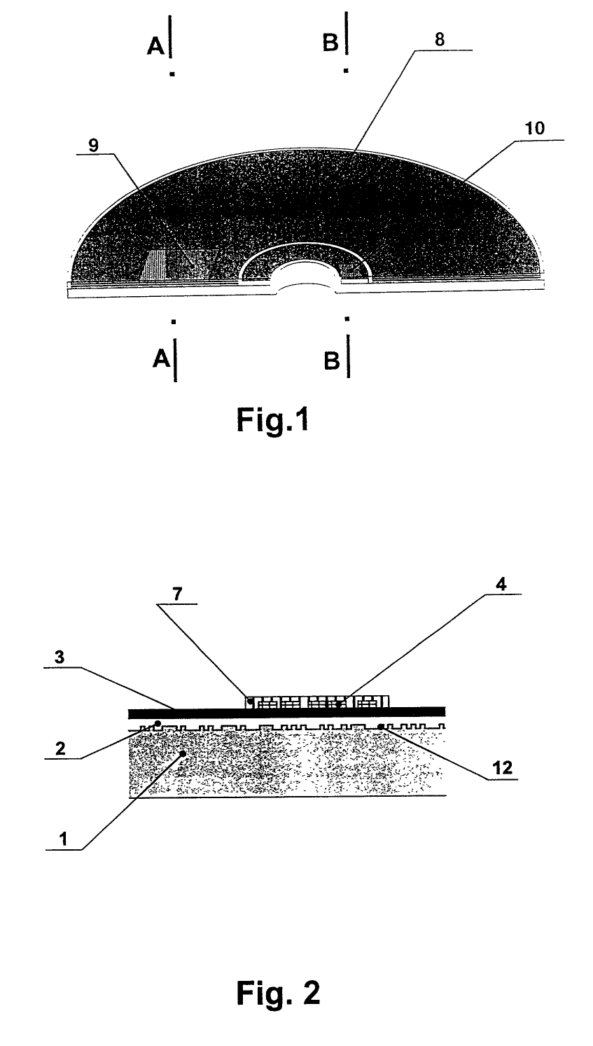

FIG. 1 shows a perspective view of a conventional compact disc in section whose top surface 8 which is not designed for scanning, contains two defined areas 9, 10 provided with a scratch-off paint 7.

FIG. 2 shows a partial sectional view of the compact disc to a highly enlarged scale on the line A—A of FIG. 1 specifically of the defined area 9 which indicates that a disc body 1 includes a spiral or concentric groove with a recording layer 12 and is covered by a reflective layer 2 that enables to make a record in the recording layer and to scan the information data contained in the groove and the recording layer by reflecting it to a recording or scanning apparatus, not shown in the drawing. The reflective layer 2 is covered by a protective coating 3 bearing in a defined area 9 a hidden printing 4. The hidden printing 4 is in the respective defined area 9 and/or 10 covered by a scratch-off paint 7 that functions as a cover paint.

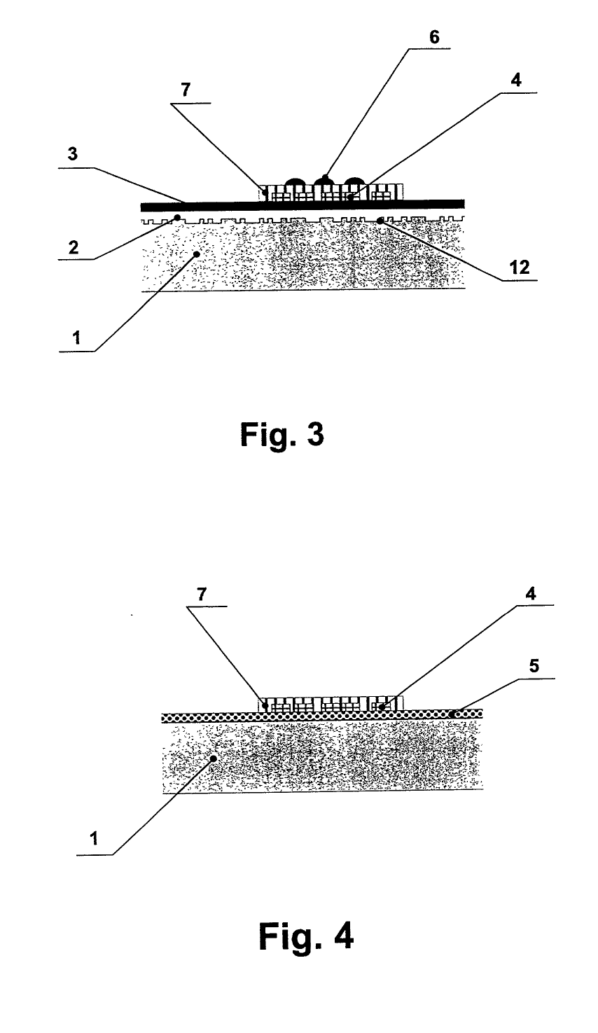

FIG. 3 shows an embodiment of a compact disc which is similar to that in FIG. 2 with the exception that the scratch-off paint 7 bears an upper guidance printing 6 that may contain certain data related to the information of the hidden printing 4.

FIG. 4 shows a partial detailed sectional view of a compact disc on the line B—B and the defined area 10 of FIG. 1 where the defined area 10 is situated in the annular, central portion of the compact disc that does not contain a reflective layer. Here, the reflective layer 2 is replaced by a basic cover paint 5 including a basic printing. Like in the preceding embodiments the hidden printing 4 is covered by the scratch-off paint 7.

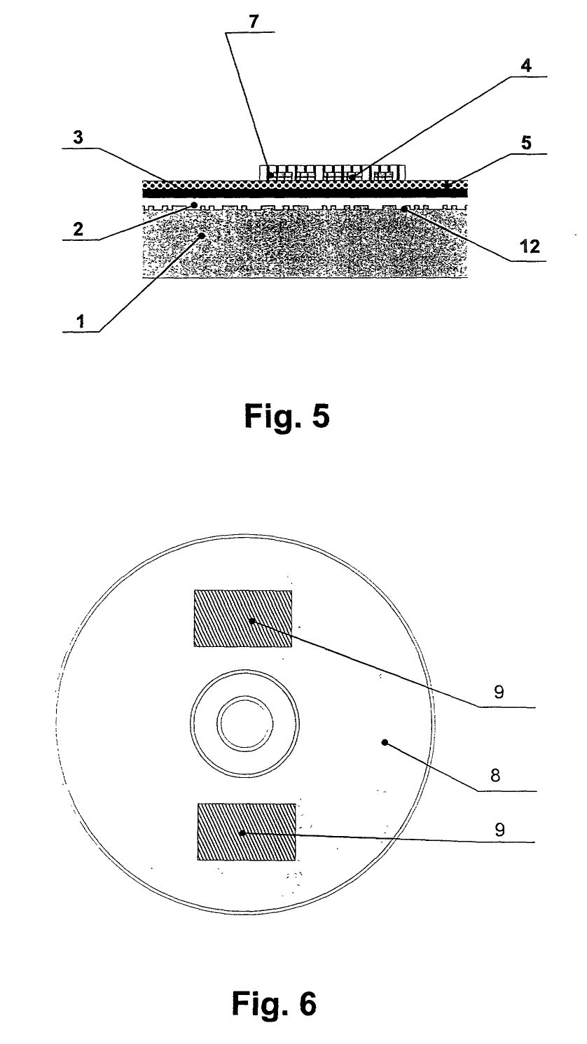

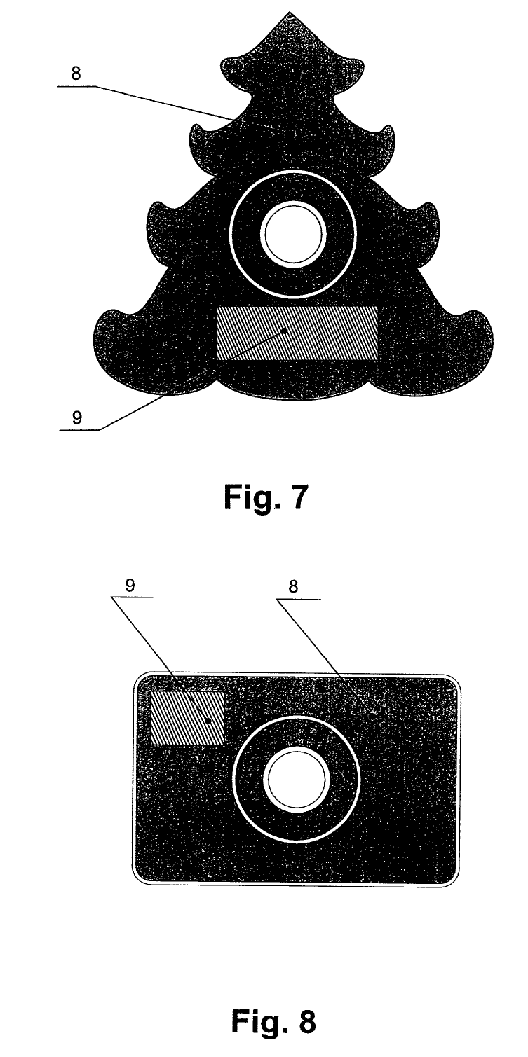

FIG. 5 shows an embodiment which is similar to that in FIG. 2 which differs only in that the protective coating 3 includes a basic cover paint 5 that includes a printing and is further provided with the hidden printing 4 covered by the scratch-off paint 7.

FIGS. 6 7, and 8 show a plan view of the top surface of the body 1 of a compact disc in three different shapes such as circular, tree and rectangular shape—performed as a business card. In these embodiments the defined area 9 bearing the scratch-off paint 7 is situated in the portion of the disc containing a recording and reflective layer.

The scratch-off paint 7 is a special developed paint used to cover a hidden printed information and available on the market under similar indication. As scratch-off paint thinner based paint, UV radiation or air hardening paint may be used. An UV radiation hardening paint may be for example based on a acrylate-phenylketene compound combination; thinner based paints may contain a thinner known under a commercial name “Stoddard” or “Naptha”. The basic feature of such paints shall be that even if hardened they may be easily mechanically removed without affecting a hidden printing underneath. As print inks used for the creation of a color picture on the top side of the compact disc UV radiation hardening print inks have been used the main component of which was a low viscous reactive acrylate. The protective coating 3 was made of UV radiation hardening transparent paint that prevents the reflective layer from oxidation and which basic component is acrylate (95%).

### INDUSTRIAL APPLICABILITY

A compact disc of circular or a non-circular shape may besides its function as a recording media fulfill an additional function as an advertisement promotional, commercial or a lottery information.

1. A compact disc of circular and non-circular shape comprising
a disc body having a central annular portion and a recording portion,
a recording and reflective layer provided on the recording portion of the disc body and covered by a protective coating,
a basic cover paint applied to said annular portion,
at least one defined area situated in the annular or recording portion containing a hidden printing,
a scratch-off paint coating covering said defined area.

2. A compact disc of claim 1 characterized in that the scratch-off paint surface bears a guidance printing.
